(19) United States
(12) Patent Application Publication
(10) Pub. No.: US 2025/0044740 A1
(43) Pub. Date: Feb. 6, 2025

(54) CLOSED-LOOP WAVEFRONT SHAPING SYSTEM AND METHOD

(71) Applicant: Centre for Perceptual and Interactive Intelligence (CPII) Limited, Hong Kong (HK)

(72) Inventors: Shih-Chi CHEN, Hong Kong (HK); Yintao WANG, Hong Kong (HK); Bingxu CHEN, Hong Kong (HK)

(21) Appl. No.: 18/363,869

(22) Filed: Aug. 2, 2023

(51) Int. Cl. G03H 1/08; G03H 1/04; G03H 1/22

(52) U.S. Cl. CPC G03H 1/0866; G03H 1/0443; G03H 1/2294

(57) ABSTRACT

Disclosed is a closed-loop wavefront shaping system, including: a parallel computing module; a task planning module; and a memory management module; wherein the system is implemented on: at least one computing device for generating digital holograms; at least one displaying device for displaying the digital holograms to control an incoming coherent light beam; and at least one sensor for detecting feedback signals.

### FIELD OF THE INVENTION

The present invention relates to a closed-loop wavefront shaping system and method, in particular a system and method of closed-loop wavefront shaping based on parallel computing of digital holography and digital micromirror device (DMD).

### BACKGROUND OF THE INVENTION

There are various typical wavefront shaping devices in the existing invention, for instance, DMD, liquid crystal spatial light modulator (LC-SLM), acousto-optical deflectors (AOD), and deformable mirrors (DM). The said DMD and LC-SLM offer the widest range of applications. Nonetheless, LC-SLM is limited by its low refresh rate, making it unsuitable for high-speed applications. In comparison among different types of computer-generated hologram (CGH) algorithms, most of the algorithms on the market prioritize the formation of high-quality holograms while the time required to achieve the formation is often neglected.

In a digital holography-based multi-focus laser scanning system, DMD is used as a programmable binary mask to display the designed holograms for modulating the incident laser or other types of coherent light wavefront to realize multi-focus 3D random-access scanning. Specifically, holograms with different spherical and tilted phases can control the laser focus axially and laterally, respectively. In former practices, although holograms can be rapidly displayed on the DMD device (e.g., at 22.7 kHz), the generation of holograms is slow. That is, digital holograms could only be generated offline and loaded into DMD memory for open-loop beam shaping. In this invention, the digital holograms are rapidly generated by a parallel computing method and can be used in a wide range of optical applications, including high-speed closed-loop 3D random access scanning for imaging and nanofabrication, high-speed 3D particle tracking and manipulation, and high-speed multi-focus 3D optical stimulation for optogenetic applications, etc.

The closed-loop setup has been applied in some wavefront shaping applications, for example, a fast closed-loop optimization wavefront shaping system can focus light through dynamic scattering media. In similar wavefront shaping applications, the devices are normally spatial light modulator (SLM) or DM. Due to the common practice of open-loop in DMD-based applications, no correction can be made in the control loop to face dynamic tasks, counterbalance turbulences, or errors that happen during wavefront shaping applications.

China Patent No. 207515742 U discloses a kind of closed-loop 3D vision devices based on digital micromirror device, which includes PC machine, control circuit, data processing module, motor, digital micro-mirror module, reference planes, and camera. A closed-loop three-dimensional vision device based on a digital micro-mirror device is disclosed, which is provided by the digital micro-mirror device, which firstly realizes rapid modulation of spatial light by the digital micro-mirror and can quickly generate a series of grating patterns. At the same time, the camera quickly collects it, and the embedded microprocessor performs three-dimensional information recovery and extraction. Finally, it is uploaded to the upper computer for display, and then the display result is processed to obtain the distance value of the object to be measured from the center of the picture, and the motor is adjusted. The digital micro-mirror module and the camera angle and focal length make the collected three-dimensional information more precise. Comparatively, the digital micromirror device in this invention is used as a 2D projector, where only the 0 order of reflection light is used and other orders are blocked. Therefore, there is a need to have a system wherein the 0 order is blocked and other (usually +1 or −1) order is used because these orders encode the information of the desired phase distribution. Moreover, the final foci shapes (grating patterns) on the target in the invention are simply a magnification or minimization of the patterns on the digital micromirror device. No CGH algorithm is used for generating these grating patterns. Hence, the foci shape on the target with Fourier transformation (or other relations caused by light interference) of displaying patterns and CGH algorithms are used to generate these patterns in the present invention.

China Patent No. 115145024 A discloses an adjusting and controlling method for shaping laser by utilizing a DMD. The method comprises the steps of shooting a shaped target area by a camera to obtain a target image, identifying the target image by using an image to obtain information about the target image, designing a phase diagram according to the information of the target image, loading the phase diagram onto a DMD, modulating the phase of the incident Gaussian laser, and focusing by a lens to generate a focusing light spot matched with the size and shape of the target image. The adjusting and controlling methods for shaping laser are based on the size and shape of the target image to realize accurate laser shaping operations. The irradiation laser is matched with the target image area, so that the positioning and treatment of the target image are realized in the smallest range as possible, and the technology has no laser damage to the normal area around the target image. Although the adjusting and controlling method could realize accurate laser shaping operation, the speed performance was unable to be improved because an iterative algorithm is applied.

United States Patent No. 2017082845 A1 discloses a device for shaping and scanning an ultrafast laser beam, including a laser source configured to output a pulsed laser beam containing a different frequency spectrum; a DMD consisting of a plurality of micromirrors, configured to receive the laser beam and shape the received laser beam with a first angular dispersion; and a dispersion compensation unit, arranged before or after the DMD, configured to transfer the laser beam from the laser source to the DMD with a second angular dispersion for neutralizing the first angular dispersion. Although the optical setups and basic CGH algorithms are disclosed in the invention, improvements on working speed and control method are needed.

Hence, there is a need to provide an ultrafast hologram computing and displaying system and method that can be implemented on a variety of devices (for instance, graphics processing unit [GPU] and DMD), to automatically generate digital holograms and control an incoming laser or other types of coherent light beam for open-loop or closed-loop high-speed wavefront shaping applications.

### SUMMARY OF THE INVENTION

It is an objective of the present invention to provide a system and method of high-speed closed-loop wavefront shaping based on parallel computing of digital holograms and digital micromirror device that provide high-speed, low computation time, and improved temporal resolution for a wide range of applications.

It is also an objective of the present invention to provide a simple installation system and method of closed-loop wavefront shaping that could be easily integrated into optical systems at a low cost.

Accordingly, these objectives may be achieved by following the teachings of the present invention. The present invention relates to a closed-loop wavefront shaping system, comprising: a parallel computing module; a task planning module; and a memory management module; wherein the system is implemented on: at least one computing device for generating digital holograms; at least one sensor for detecting feedback signals; and at least one digital micromirror device (DMD) for displaying the digital holograms to control an incoming coherent light beam.

### BRIEF DESCRIPTION OF THE DRAWINGS

The features of the invention will be more readily understood and appreciated from the following detailed description when read in conjunction with the accompanying drawings of the preferred embodiment of the present invention, in which:

FIG. 1 illustrates existing approaches to generate multiple holograms;

FIG. 2 illustrates a graph diagram of algorithm performance for different frame batches;

FIG. 3 illustrates an example of a system design that overcomes a low data transfer rate;

FIG. 4 illustrates two working modes of the wavefront shaping system in the present invention;

FIG. 5 illustrates a core workflow of a DMD-based wavefront shaping system;

FIG. 6 illustrates a simple workflow for a DMD-based tracking system;

FIG. 7 illustrates a workflow of a DMD-based tracking system in GPU-only mode in the present invention;

FIG. 8 illustrates a workflow of a DMD-based tracking system in look up table (LUT)-only mode in the present invention;

FIG. 9 illustrates a workflow of a DMD-based tracking system in a mixed working mode of GPU and LUT in the present invention;

FIG. 10 illustrates an example of a closed-loop control system with ultrafast DMD beam shaping in the present invention;

FIG. 11A illustrates a closed-loop wavefront shaping system in the present invention; and

FIG. 11B illustrates a scanning trajectory for the localization of a fluorescent particle in the present invention.

### DETAILED DESCRIPTION OF THE PREFERRED EMBODIMENT

For the purposes of promoting and understanding of the principles of the invention, reference will now be made to the embodiments illustrated in the drawings and described in the following written specification. It is understood that the present invention includes any alterations and modifications to the illustrated embodiments and includes further applications of the principles of the invention as would normally occur to one skilled in the art to which the invention pertains.

The present invention teaches a closed-loop 102 wavefront shaping system, comprising: a parallel computing module 702; a task planning module 704; wherein the system is implemented on: at least one computing device 104 for generating digital holograms; at least one sensor 106 for detecting feedback signals; and at least one displaying device for displaying the digital holograms to control an incoming coherent light beam.

In a preferred embodiment of the present invention, the parallel computing module 702 comprises Lee holography 504.

In a preferred embodiment of the present invention, the displaying device comprises digital micromirror device (DMD) 502.

In a preferred embodiment of the present invention, the Lee holography 504 is solved parallelly based on an equation:

$$h ( i , j ) = \{ \begin{matrix} & & i = tid \% m + 1 \\ 1 , & - q \leq φ ( x , y ) \leq q , & j = tid // n + 1 \\ & & x = {p}_{x} \cdot ( i - m / 2 ) \\ 0 , & otherwise , & y = {p}_{y} \cdot ( j - n / 2 )\end{matrix}$$

wherein h(i,j) is the digital hologram; φ(x,y) is the target wavefront on DMD 502 chip; q is the digitalization constant; and % and // are modulus and floor division, respectively; m, n are the maximum pixel counts in each row and column of a DMD 502; i,j are the pixel indices (coordinates) of a 2D hologram with a range of i1≤i≤i2, j1≤j≤j2 and 1≤i1≤i2≤m, 1≤j1≤j2≤n; tid is the integer index (serialized by rows) of 1D calculating threads with a range of 0≤tid≤m·n−1; x,y are the physical position (coordinates) on a DMD 502 chip; and pₓ and p_{y} are the pixel sizes in the x and y directions.

In a preferred embodiment of the present invention, the Lee holography 504 is solved parallelly based on an equation:

$$h ( i , j ) = \{ \begin{matrix} & & i = tid // m + 1 \\ 1 , & - q \leq φ ( x , y ) \leq q , & j = tid \% n + 1 \\ & & x = {p}_{x} \cdot ( i - m / 2 ) \\ 0 , & otherwise , & y = {p}_{y} \cdot ( j - n / 2 )\end{matrix}$$

wherein h(i,j) is the digital hologram; φ(x,y) is the target wavefront on DMD 502 chip; q is the digitalization constant; and % and/are modulus and floor division, respectively; m, n are the maximum pixel counts in each row and column of a DMD 502; i,j are the pixel indices (coordinates) of a 2D hologram with a range of i1≤i≤i2, j1≤j≤j2 and 1≤i1≤i2≤m, 1≤j1≤j2≤n; tid is the integer index (serialized by rows) of 1D calculating threads with a range of 0≤tid≤m·n−1; x,y are the physical position (coordinates) on a DMD 502 chip; and pₓ and p_{y} are the pixel sizes in the x and y directions.

In a preferred embodiment of the present invention, the computation of holograms is accelerated by arranging multiple frames into a single computing task.

In a preferred embodiment of the present invention, the task planning module 704 is configured to control, organize, and optimize the performance of the system. The holograms are determined to be computed individually or in batch.

In a preferred embodiment of the present invention, the computing device 104 comprises at least one or combinations of graphics processing unit (GPU), central processing unit (CPU), distributed computing system, field programmable gate array (FGPA) 708, the displaying device comprises at least one or combinations of digital micromirror device (DMD) 502, spatial light modulator (SLM), deformable mirror (DM), grating light valve (GLV), planar light valve (PLV) and the sensor 106 comprises at least one or combinations of camera, photomultiplier tube (PMT) 706, photodiode (PD), avalanche photodiode (APD), single-photon detector (SPD), laser power meter, beam profiler, Shack-Hartmann sensor and spectrometer. The DMD 502 maybe replaceable or a combination with spatial light modulator (SLM), deformable mirror (DM), grating light valve (GLV), and planar light valve (PLV), which is configured as displaying device.

In a preferred embodiment of the present invention, the system further comprises a memory management module 802 configured to reuse holograms that have been preloaded to the on-board memory of displaying devices and coordinate the memory usage between the computing devices 104 and the displaying devices and such holograms are re-displayed by providing hologram indices to the control board of the displaying devices.

In a preferred embodiment of the present invention, the system further comprises at least one control module to improve the stability, precision and accuracy of the system and accomplish tasks at high speeds in complex environments.

In a preferred embodiment of the present invention, the displaying device comprises at least one or combinations of spatial light modulator (SLM), deformable mirror (DM), grating light valve (GLV), and planar light valve (PLV).

The present invention also teaches a closed-loop 102 wavefront shaping system, comprising: a computing module for generating holograms using a computer-generated hologram (CGH) algorithm; a memory management module 802, such memory management module is configured to reuse holograms that have been preloaded to the on-board memory of displaying devices and coordinate the memory usage between computing devices 104 and displaying devices; wherein the system is implemented on: at least one computing device 104 for generating digital holograms; at least one sensor 106 for detecting feedback signals; and at least one displaying device for displaying the digital holograms to control an incoming coherent light beam.

In a preferred embodiment of the present invention, the system with computing module for generating holograms using the CGH algorithm further comprises at least one control module to improve the stability, precision and accuracy of the system and accomplish complex tasks at high speeds in complex environments.

In a preferred embodiment of the present invention, the displaying device comprises at least one or combinations of digital micromirror device (DMD) 502, spatial light modulator (SLM), deformable mirror (DM), grating light valve (GLV), and planar light valve (PLV).

The present invention also teaches a method based on closed-loop 102 wavefront shaping for particle tracking, comprising the steps of: scanning in a fixed trajectory, such trajectory consists of one or multiple points in 3D space; acquiring and analyzing fluorescent intensity signals; repeating the scanning of the fixed trajectory until at least one intensity peak higher than a set threshold is detected; initializing the location of the particle using the location of the detected intensity peak; scanning the particle with a 3D foci array; estimating and renewing the particle location with the detected intensity signals and the foci locations of the 3D foci array; repeating the scanning of 3D foci array around the updated particle location to form a closed-loop particle tracking; and checking the exit criteria during each tracking iteration to decide when to stop the tracking.

In a preferred embodiment of the present invention, the scanning of the fixed trajectory comprises the steps of: generating and loading holograms of the fixed trajectory using a parallel computing module 702 and a task planning module 704; transferring all holograms to a digital micromirror device (DMD) 502; sending start commands to the DMD 502 to initiate the fixed trajectory scanning sequence; and sending trigger signals to the DMD 502 to display holograms one-by-one and simultaneously detecting the corresponding fluorescent intensity signals.

In a preferred embodiment of the present invention, the repeating of the scanning of the fixed trajectory comprises the steps of: sending start commands to a digital micromirror device (DMD) 502 to restart the fixed trajectory scanning hologram sequence; and sending trigger signals to the DMD 502 to display holograms one-by-one and simultaneously detecting the corresponding fluorescent intensity signals.

In a preferred embodiment of the present invention, the scanning of particle with a 3D foci array comprises the steps of: transferring the particle location to the parallel computing module 702 and task planning module 704 for generating a 3D foci array around the detected location; transferring all holograms to a digital micromirror device (DMD) 502 for 3D foci array scanning; sending start commands to the DMD 502 to initiate the 3D foci array scanning sequence; sending trigger signals to the DMD 502 to display holograms one-by-one and simultaneously detecting the corresponding fluorescent intensity signals; and calculating new current location of the particle after getting all the intensity signals.

In a preferred embodiment of the present invention, the repeating of the scanning of 3D foci array comprises the steps of: sending the new particle location to the parallel computing module 702 and task planning module 704 for generating a 3D foci array around the new particle location; transferring all holograms to a digital micromirror device (DMD) 502 for 3D foci array scanning; sending start commands to the DMD 502 to initiate the 3D foci array scanning sequence; sending trigger signals to the DMD 502 to display holograms one-by-one and simultaneously beginning the corresponding data collection; detecting fluorescent intensity signals; and calculating new current location of the particle after getting all the intensity signals.

In a preferred embodiment of the present invention, the method further comprises the steps of: generating the holograms that can cover a relatively large 3D space using a parallel computing module 702 and a task planning module 704; transferring all holograms to a digital micromirror device (DMD) 502; generating hologram indices that form a fixed trajectory using a memory management module 802, such hologram indices correspond to specific holograms loaded in the DMD 502; transferring all hologram indices for fixed trajectory to the DMD 502; sending start commands to the DMD 502 to initiate the fixed trajectory sequence; and sending trigger signals to the DMD 502 to display holograms one-by-one and simultaneously detecting the corresponding fluorescent intensity signals.

In a preferred embodiment of the present invention, the method further comprises the steps of: transferring the particle location to the memory management module 802 for generating 3D foci array indices from the loaded holograms around the detected location, such holograms indices correspond to specific holograms loaded in DMD 502; transferring all holograms indices for 3D foci array to the DMD 502; sending start commands to the DMD 502 to initiate the 3D foci array sequence; sending trigger signals to the DMD 502 to display holograms one-by-one and simultaneously detecting the corresponding fluorescent intensity signals; and calculating new current location of the particle after getting all the intensity signals.

In a preferred embodiment of the present invention, the method further comprises the steps of: generating new series of holograms to cover a new area if a particle moves near the border of the frame using the parallel computing module 702 and task planning module 704; loading the new series of holograms to the DMD 502; wherein the old series of holograms in DMD 502 memory is freed to provide enough space for the new series of holograms.

The present invention also teaches a method of closed-loop 102 wavefront shaping for particle tracking, comprising the steps of: generating and loading 3D scan holograms that can cover a relatively large 3D space using at least one computer-generated hologram (CGH) algorithm; generating and loading hologram indices for a fixed trajectory using a memory management module 802, such trajectory consists one or multiple points in 3D space; displaying holograms in the fixed trajectory sequence and controlling the laser foci to scan over sample; acquiring and analyzing fluorescent intensity signals to determine appearance of any intensity peak higher than a set threshold; repeating the scanning of the fixed trajectory until at least one intensity peak is detected; initializing the location of the particle using the location of the detected intensity peak; scanning the particle with hologram indices that form a 3D foci array, such indices are generated by the memory management module 802; estimating and renewing the particle location with the detected intensity signals and the foci locations of the 3D foci array; repeating the scanning of 3D foci array to form a closed-loop 102 particle tracking; and checking the exit criteria during each tracking iteration to decide when to stop the tracking.

In a preferred embodiment of the present invention, the generating and loading of hologram indices for the fixed trajectory comprises the steps of: calculating the hologram indices for the fixed trajectory using memory management module 802; and transferring all hologram indices to a digital micromirror device (DMD) 502 for fixed trajectory scanning.

In a preferred embodiment of the present invention, the repeating of the scanning of fixed trajectory comprises the steps of: sending start commands to a digital micromirror device (DMD) 502 to restart the fixed trajectory scanning hologram sequence; and sending trigger signals to the DMD 502 to display holograms one-by-one and simultaneously detecting the corresponding fluorescent intensity signals.

In a preferred embodiment of the present invention, the scanning of the particle with hologram indices that forms a 3D foci array comprises the steps of: transferring the particle location to the memory management module 802 for generating hologram indices for 3D foci array around the detected location; sending start commands to a digital micromirror device (DMD) 502 to initiate the 3D foci array sequence; sending trigger signals to the DMD 502 to display holograms one-by-one and simultaneously detecting the corresponding fluorescent intensity signals; and calculating new current location of the particle after getting all the intensity signals.

In a preferred embodiment of the present invention, the memory management module 802 is configured to coordinate the high- and low-speed memory usage between computing devices 104 and displaying devices and to reuse holograms that have been pre-loaded into the high-speed on-board memory of the displaying device.

In a preferred embodiment of the present invention, the CGH algorithm includes but not limited to a hologram generating method of a commercial product.

### Example

In the present invention, the closed-loop 102 wavefront shaping system generates and manages digital holograms by using three modules: a parallel computing module 702, a task planning module 704, and a memory management module 802. According to Lee holography 504, the phase of the on or off states of each pixel on a DMD 502 is determined when a target wavefront function is given. The solution to the wavefront function may vary according to different situations. But in the case that only a few foci are involved (i.e., less than 10 foci), the wavefront function can be solved by adding up basic wavefronts with random initial phases. With this simplification, the pixel states can be independently calculated in parallel computing threads. Thus, the synthesis of the holograms can be accelerated by various parallel computing architectures, such as multi-threaded CPUs, GPUs, or distributed computing architectures.

In practice, the target wavefront φ(x,y) on a DMD 502 is a superposition or summation of different wavefronts. For instance, a defocused LG beam with lateral tilt can be expressed as:

$$φ ( x , y ) = {φ}_{Tilt} ( x , y ) + {φ}_{Sphere} ( x , y ) + {φ}_{LG} ( x , y ) \qquad ( 1 )$$

Where φ_{Tilt}(x,y), φ_{Sphere}(x,y), and φ_{LG}(X,y) can be expressed as:

$$\{ \begin{matrix}{φ}_{Tilt} ( x , y ) = 2 π \cdot \frac{{R}_{k} ( x , y )}{{T}_{k}} \\ {φ}_{Sphere} ( x , y ) = \frac{π ( {x}^{2} + {y}^{2} )}{λ f} \\ {φ}_{LG} ( x , y ) = \{ \begin{matrix}{tan}^{- 1} \frac{y}{x} , & x \geq 0 \\ {tan}^{- 1} \frac{y}{x} + π , & x < 0\end{matrix}\end{matrix} \qquad ( 2 )$$

To determine the pixel value of a digital hologram in individual computing threads, an extra step is needed to reshape the 2D wavefront φ(x,y) into a 1D form. A solution is to serialize the 2D hologram via columns or rows into a 1D array, where the indices of the reshaped array correspond to the indices of individual computing threads, as expressed in (3):

$$h ( i , j ) = \{ \begin{matrix} & & i = tid \% m + 1 \\ 1 , & - q \leq φ ( x , y ) \leq q , & j = tid // n + 1 \\ & & x = {p}_{x} \cdot ( i - m / 2 ) \\ 0 , & otherwise , & y = {p}_{y} \cdot ( j - n / 2 )\end{matrix} \qquad ( 3 )$$

wherein h(i,j) is the digital hologram;
φ(x,y) is the target wavefront on DMD 502 chip;
q is the digitalization constant;
% and // are modulus and floor division, respectively;
i, j are the pixel indices (coordinates) of the 2D hologram with a range of 1≤i≤m, 1≤j≤n and m, n are the maximum pixel counts in each row and column of a DMD 502;
tid is the integer index (serialized by rows) of 1D calculating threads with a range of 0≤tid≤m·n−1;
x, y are the physical position (coordinates) on the DMD 502 chip; and
pₓ and p_{y} are the pixel sizes in the x and y directions.

After linking hologram pixels to individual calculating threads, multiple concurrent calculating threads can be created to reduce the time for hologram generation. This method can be realized on different hardware setups. It is important to note that the required time is usually inversely related to the level of parallelism. For instance, a multi-core or multi-processor computer can only accelerate a computing process by less than 10 times because most CPUs only support less than 10 parallel threads. However, for massively parallel architectures such as GPUs and distributed computing architectures, the time expense for generating holograms can be greatly reduced by more than 1000 times.

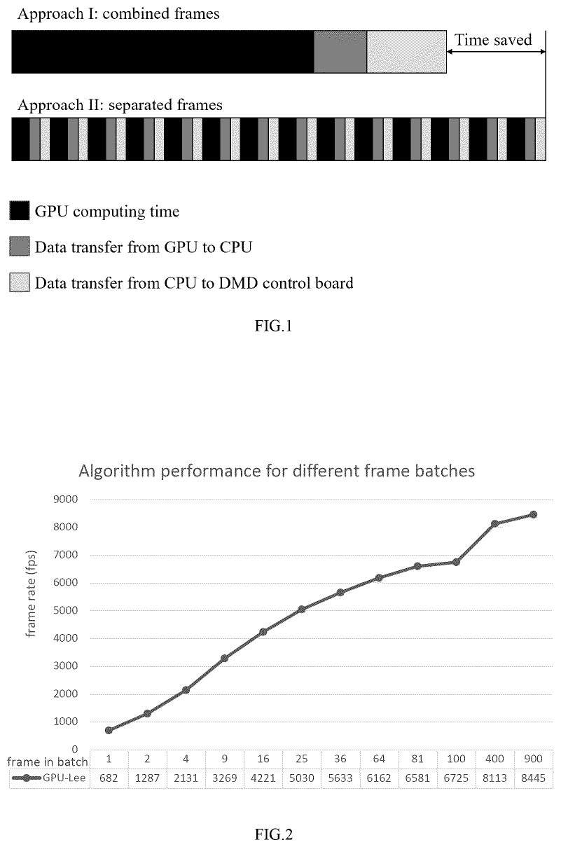

According to the task planning module 704, holograms are controlled by how they are organized and generated in batches. The task planning module 704 optimizes the performance of the system by first determining whether holograms should be computed individually or in batches. After that, holograms are automatically generated by the parallel computing module 702. For instance, when generating multiple holograms in a control loop, there are two common approaches, as illustrated in FIG. 1. The first approach combines all or some of the holograms into a single computing task. The GPU transfers holograms only after all frames have been generated. In this approach, the switching between devices (i.e., GPU, CPU, and DMD 502) is minimized as the GPU (or CPU) is only called once. This approach minimizes the average time expense for generating each hologram. The second approach calculates and transfers the holograms one-by-one among the GPU, CPU, and DMD 502. Although this approach seems to have a longer processing time due to the frequent device switching and data transfer, it may be more efficient for certain application scenarios, such as applications that require shorter latency for individual frames.

The task planning module 704 further controls how the parallel computing module 702 works and improves the system's performance by improving overall speed, real-time capability etc. by balancing the average time expense and shortest hologram latency. To further illustrate the performance on average time expense, FIG. 2 shows an increasing hologram generating speed and a decreasing average time expense for each hologram when more holograms are computed together by the parallel computing module 702. Specifically, when holograms are computed one-by-one, the frame rate is 682 fps, which means the average time expense for generating one hologram is around 1.47 milliseconds. However, when multiple holograms (e.g., 400) are computed together, the parallel computing module 702 can work at 8113 fps. The average time expense decreases to 0.123 milliseconds per hologram.

However, the highest frame rate with lowest average time expense for each hologram is not always the best option because the more holograms calculated in a batch, the longer the hologram latency. Taking the one-by-one and 400-by-400 scenarios as examples, when generating holograms in a one-by-one manner, the DMD 502 starts to show holograms 1.47 milliseconds after the calculation starts. But in a 400-by-400 setup, the DMD 502 starts to show holograms after 49.2 (0.123×400) milliseconds. This delay is not favorable in real-time applications such as particle tracking because the target may get lost after a relatively long period of time.

In practice, the task planning module 704 decides the hologram batch size according to the application or scenario. For instance, in static applications such as DMD-based 502 laser printing, hologram latency does not influence the system performance much. The task planning module 704 tends to generate more holograms together in a large batch size to get the shortest average time expense and thereby shortens the overall printing time. But in applications that needs high real-time performance such as tracking a fluorescent particle, task planning module 704 tries to send small batches to parallel computing module 702 to get the shortest hologram latency.

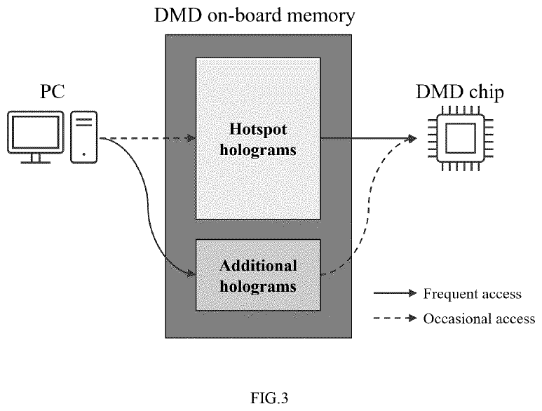

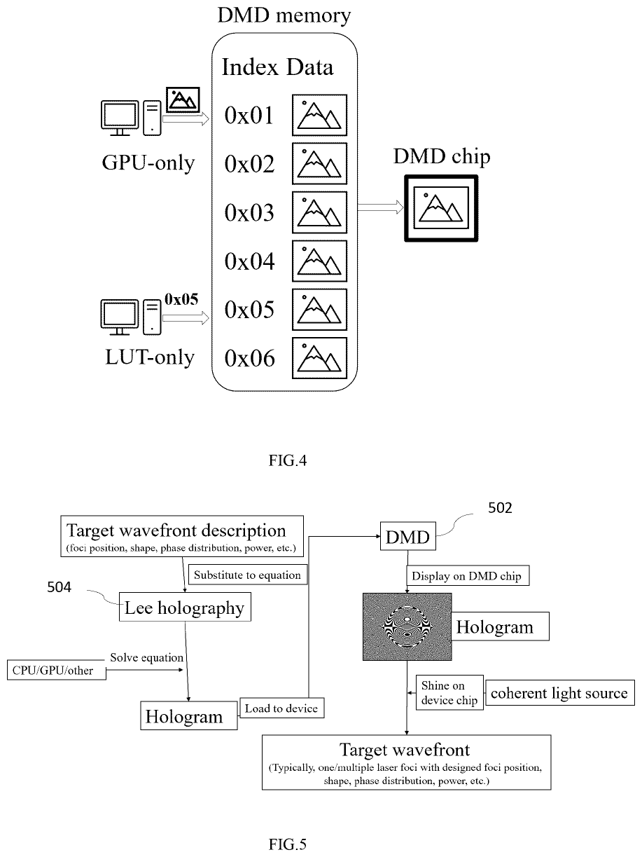

For the memory management module 802, the high- and low-speed memory usage is coordinated between the computing devices 104 and displaying devices. The computing devices 104 include but are not limited to the GPU, CPU, distributed computing system, and FPGA 708. Meanwhile the displaying devices include but are not limited to the DMD 502, SLM, and DM. The memory management module 802 reduces system latency by reusing holograms that have been pre-loaded into the high-speed on-board memory of the displaying device. For instance, the universal serial bus (USB) port used on the DMD 502 control board has a limited bandwidth of 480 Mbit/s. This restricts the hologram receiving rate to approximately 4,000 fps and limits the closed-loop 102 frame rate to less than 4,000 fps, or less than ⅕ of the maximum DMD 502 frame rate. To overcome this bottleneck, a set of hotspot holograms is pre-loaded into the DMD 502 on-board memory as shown in FIG. 3. The hotspot holograms are frequently reused by sending indices of hotspot holograms in the subsequent control loops. Also, if holograms outside the hotspot list are required, the parallel computing module 702 generates and loads new holograms to the DMD 502. In practice, this design can enhance the system's performance by achieving a near-100% DMD 502 maximum display frame rate.

The memory management module 802 has a mutually supplementary relationship with the parallel computing module 702 and the task planning module 704. No new holograms are needed to be generated after the first load and, therefore, the time spent on hologram generation and transfer is saved. Therefore, a lot of slow CGH algorithms can cooperate with the said memory management module 802 in the present invention and obtain an ultrahigh displaying speed.

The memory management module 802 can either work alone or work with the parallel computing module 702 and task planning module 704. When all three modules work together, the system can display limitless holograms or wavefront shaping (WFS) capabilities at ultrahigh speed. The parallel computing module 702 and task planning module 704 of a standalone system can work at a reasonably high speed with a limitless number of holograms because all holograms are freshly generated. Meanwhile, a standalone memory management module 802 system can work with other slow hologram generation methods and perform ultrahigh hologram display speeds. In practice, the memory management module 802 can be realized by an application programming interface (API) function of a commercial product. Specifically, users can reuse arbitrary holograms stored in DMD 502 memory by sending the corresponding hologram index. This function is called the frame look up table (FrameLUT or LUT) in DMD 502 control boards produced by ViALUX Gmbh.

Specifically, when the parallel computing module 702 and task planning module 704 work alone in GPU-only mode, as shown in FIG. 4, the holograms are generated by the GPU and transported to DMD 502 every time a hologram is needed. For the LUT-only mode, the holograms are first generated by the parallel computing module 702 and task planning module 704, or other kinds of algorithms and then transported to DMD 502 memory. When a specific hologram is needed, the controlling software transfers the index of the hologram that is stored in DMD 502 memory. Compared with GPU-only mode, LUT-only mode only transfers index data instead of hologram data. The data size is much smaller, typically 1 LUT:200,000 GPU. Therefore, the time for hologram generation and transfer is saved.

In particle tracking applications, parallel computing module 702 and task planning module 704 with GPU-only mode can track particles moving at ˜20 m/s within a 50×50×50 μm³ range (range limited by the optical system). When it comes to memory management module 802 standalone with LUT-only mode, the maximum trackable speed increases to ˜200 m/s, but the tracking range decreases to 20×20×20 μm³ because only a limited number of holograms can be pre-loaded into DMD 502 memory. When all three modules work together with both LUT and GPU modes, the tracking range is 50×50×50 m³ and the tracking speed is slightly below 200 μm/s.

FIG. 5 shows a core part of a DMD-based 502 WFS system wherein no closed-loop 102 is involved. In some applications, the targets are highly dynamic, such as a free-moving mouse or a free-diffusing fluorescent particle. Holograms should be generated and displayed at a very high speed to shorten the system latency and thereby follow up with the target. Accordingly, the parallel computing module in the present invention can solve Lee holography 504 equations at a high speed.

Single particle tracking (SPT) is a technique used in biomedical research and engineering to study the movement of microscopic particles. The particles are usually labelled with a fluorescent dye, which could emit light when excited by a laser or other light source. The movement of the particles can then be tracked using a detector and specialized software. Basically, SPT uses different scanners such as galvo-mirrors, electro-optical deflectors (EODs), piezo-stages, etc. to scan laser foci around the target particle. The detectors, such as cameras, photodiodes, etc., receive intensity signals that are negatively correlated with the foci-particle distance (i.e., the nearer the distance, the higher the intensity). With enough data on intensity versus foci location, the position of a fluorescent particle can be estimated.

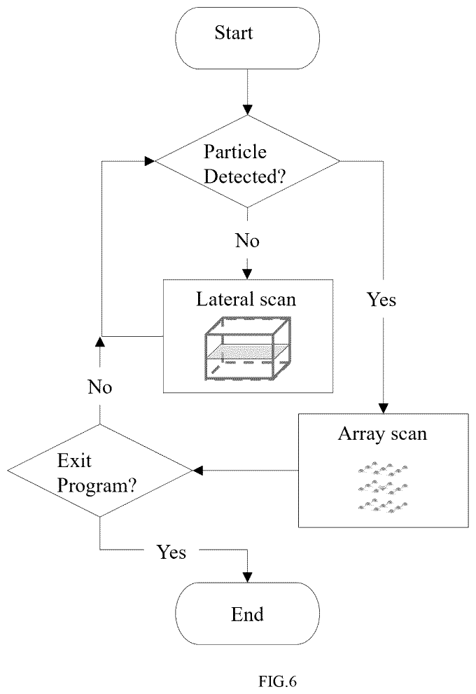

FIG. 6 shows a simple workflow for a DMD-based 502 tracking system. The tracking process starts with iterations of a fixed trajectory of 2D lateral scan, which resembles the scan trajectory of a typical confocal microscope. During each fixed trajectory of 2D lateral scan, the controlling program acquires and analyze the returned fluorescent intensity signals. The system repeats the fixed trajectory of 2D lateral scan until an intensity peak higher than threshold is detected, which means a fluorescent particle has passed through the 2D scanning area and the location of the particle is initialized. After getting the first location, the 2D lateral scan is stopped, and the DMD-based 502 WFS system iteratively scans around the particle with a 3D foci array (typically 3×3×3) to update the particle location. During each tracking iteration, the controlling program also checks the exit criteria to see when to stop the tracking process. There are mainly two kinds of exit criteria. The first one is user interruption, which means the user inputs an exit signal to stop the whole process. The second one is lost target criteria, which means the acquired intensity signal is too weak to stand out from the background noise.

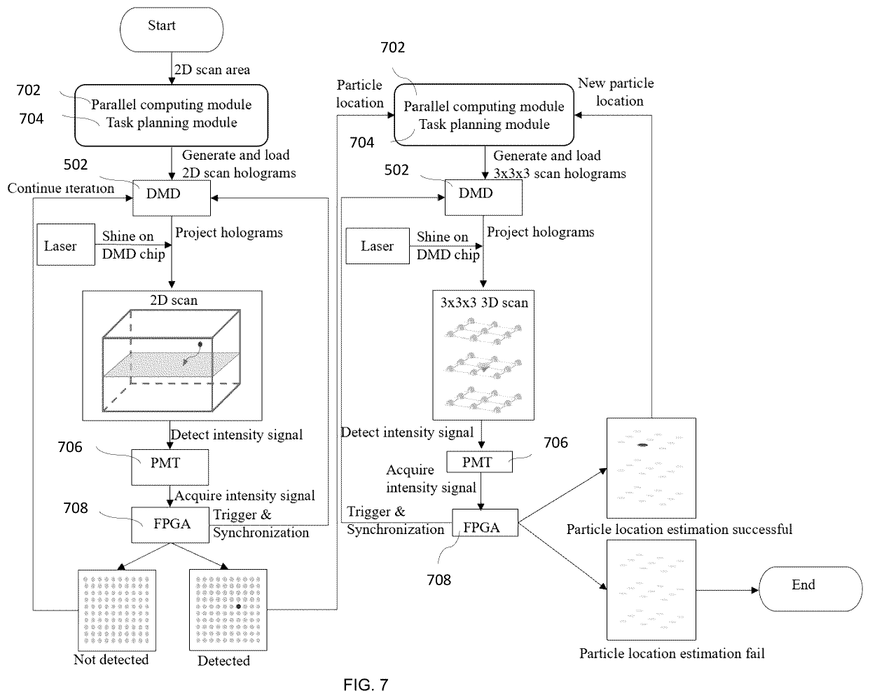

As mentioned above, the DMD-based 502 WFS system in the present invention comprises three working modes. The first working mode is GPU-only mode, which only uses the parallel computing module 702 and task planning module 704, as shown in the detailed workflow of FIG. 7. When the tracking process starts, the controlling program first calls the parallel computing module 702 and task planning module 704 to generate a fixed trajectory of 2D lateral scan. For instance, if the user wants to scan over a 50×50 μm² area with a 1 μm step along each axis, then 50×50 foci locations are needed to cover up the 2D scan area. As the hologram delay is not a priority at the start of the tracking process, the task planning module 704 allocates all 2,500 foci locations into one computing task and pass it to the parallel computing module 702. After calculation, the parallel computing module 702 transfers all the 2,500 holograms to DMD 502. When the DMD 502 receives the synchronization signal from the FPGA 708, the 2D scan starts. The DMD 502 displays the 2,500 holograms frame by frame, and the corresponding laser foci under the microscope start to move 1 μm by 1 μm. During the display time of each frame, the PMT 706 detects the fluorescent intensity signal and passes it to the FPGA 708. Since FPGA 708 and DMD 502 are synchronized, the hologram is changed when DMD 502 receives a signal from FPGA 708, and the intensity distribution against foci location can be obtained. After each 2D scan iteration, this intensity map is analyzed to see if any intensity peaks appear. If no peak is detected, the 2,500 holograms is displayed again until at least one peak is detected, after which the holograms are not displayed again.

When a fluorescent particle is detected by the fixed trajectory of 2D scan, the location with 3D coordinates, e.g., x=50 μm, y=0 μm, z=0 μm of the particle is transferred to the parallel computing module 702 and task planning module 704 to generate a 3D foci array around the detected location. Typically, the array consists of 3×3×3 foci around the detected particle. The foci are also separated by a given step size. After the preparation of the holograms, the FPGA 708 sends starting signals to the DMD 502, and the corresponding data collection process simultaneously begins. This data acquisition process is similar to the 2D scan process described above. After getting all 27 intensity signals, the controlling software calculates the current location of the particle. Then, this renewed particle location is sent to the parallel computing module 702 and task planning module 704 to start up the next iteration. A closed-loop 102 tracking system is formed and is repeated until the exit criteria are met.

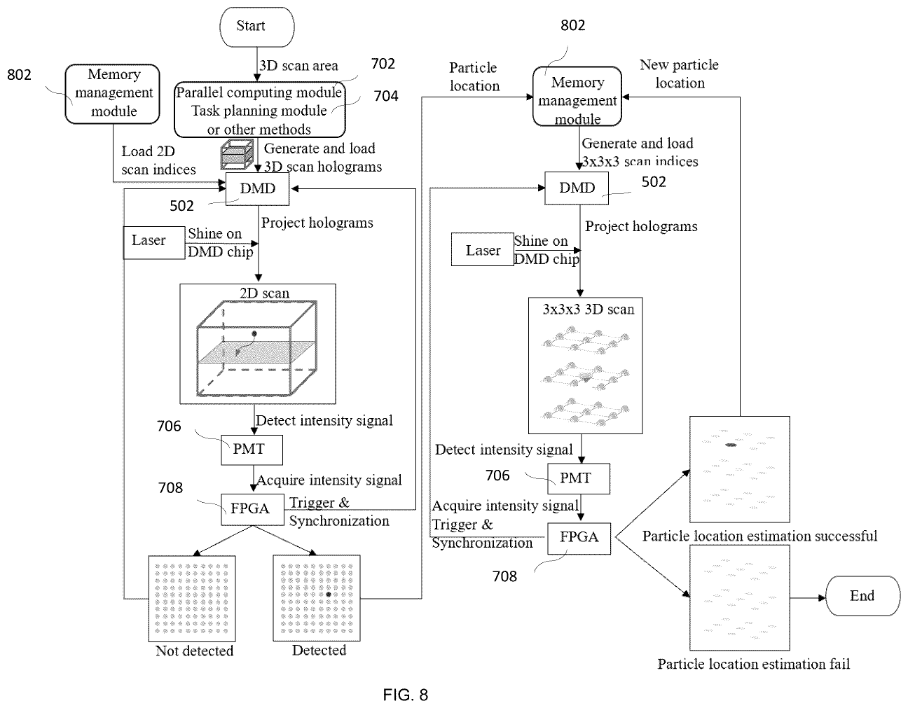

FIG. 8 shows the detailed workflow for the LUT-only mode, which uses the memory management module 802 and any type of CGH algorithm. The system starts up with hologram generating modules like the parallel computing module 702 and the task planning module 704. Different from the initial 2D scan in GPU-only mode, the LUT-only mode generates and loads holograms that can cover a relatively large 3D space, whose size is limited by DMD 502 memory size and the physical tracking range limited by the optical setup. No new holograms are generated afterwards. The initializing of fixed trajectory of 2D scan and closed-loop 102 3D (3×3×3 array) scan trajectories are made up by the memory management module 802. Specifically, to form a 2D scan trajectory, the memory management module 802 loads hologram indices that have the same Z coordinate if the scan is on the XY plane. The 3×3×3 array is also formed in the same way.

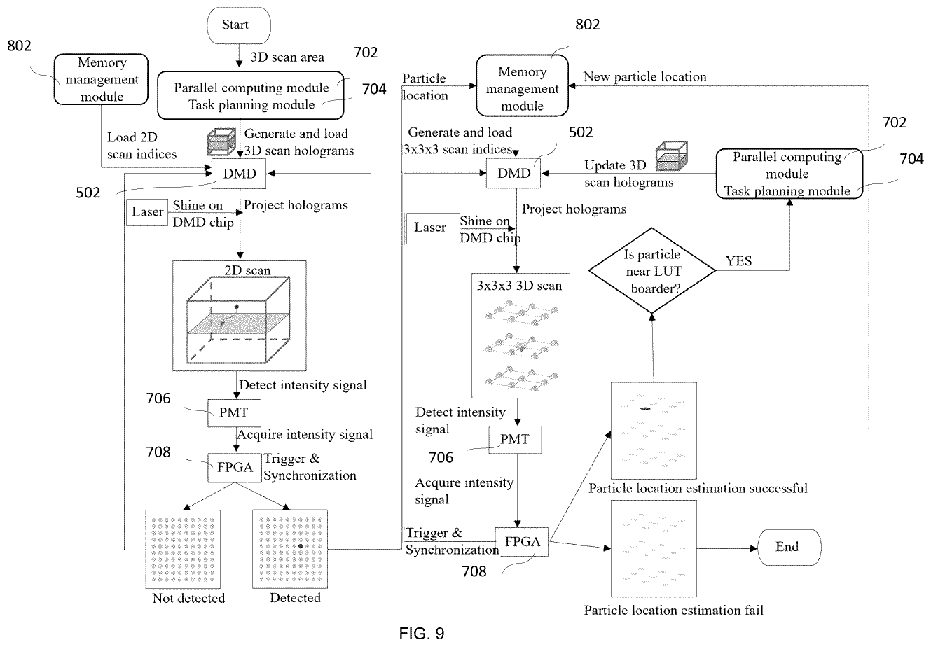

FIG. 9 is the detail tracking workflow under GPU-LUT mode. In this setup, all three modules cooperate to get the optimum tracking range and tracking speed. The first detection of fluorescent particles is identical to the LUT-only mode. However, when a particle moves near the boarder of the green cube in the closed-loop 102 particle tracking process, new series of holograms that cover the new area are generated by the parallel computing module 702 and task planning module 704. After the new sets of holograms are generated and loaded into DMD 502, the old hologram series are freed to guarantee there is enough space in DMD 502 memory.

To achieve closed-loop 102 control of wavefront shaping, additional sensors 106 and control strategies need to be implemented. According to the different applications, one or multiple sensors 106 can be a camera, photomultiplier tube (PMT) 706, photodiode (PD), avalanche photodiode (APD), single-photon detector (SPD), laser power meter, beam profiler, Shack-Hartmann sensor, spectrometer, etc. And control strategies may include PID control, Kalman filtering etc. By implementing a closed-loop 102 design, the system can achieve higher accuracy and precision at high speed to facilitate new functions, such as multi-target tracking or closed-loop 3D printing.

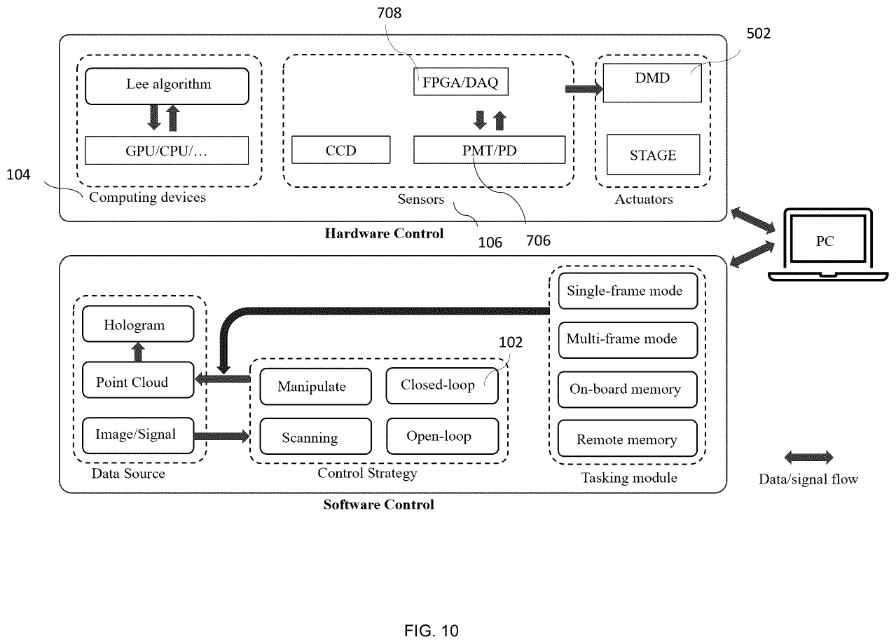

For example, to use the DMD 502 beam shaper as a multi-focus optical manipulation system, a CCD camera can be used as a sensor 106 device. The high-speed DMD 502 wavefront shaper traces and manipulates the target particles (e.g., cells or silica spheres) within the DMD 502 working range. An XYZ stage can be employed to move the particles when the destination is outside the DMD 502 workspace. The control flow chart is illustrated in FIG. 10.

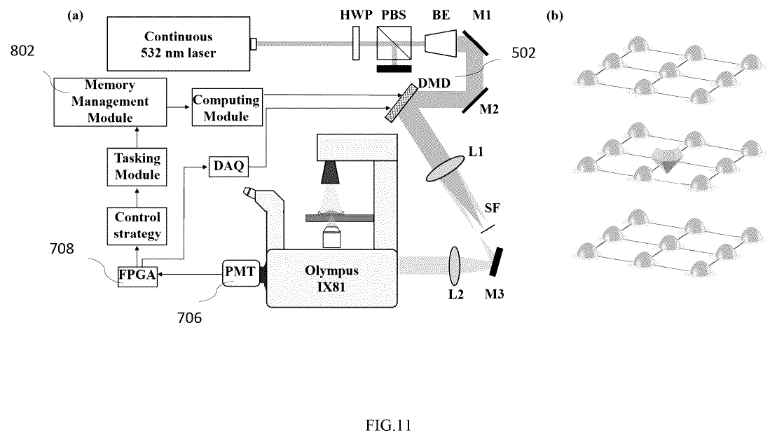

In addition, the said hardware is easily integrated into the method and system of the present invention for particle tracking, manipulation, and nano-3D printing applications at a low hardware cost. Specifically, the present invention is integrated with a commercial microscope to perform random-access scanning and particle tracking, as shown in FIG. 11. In this setup, a train of optic components, including the half-wave plate (HWP), polarizing beam splitter (PBS), beam expander (BE), and a pair of mirrors, are introduced to control the laser power, beam diameter, and angle before entering the DMD 502. The beam angle entering the DMD 502 is calculated based on the diffraction equation to match the blazing angle. After the DMD 502, a 4-f system (i.e., lenses L1 [f=100 mm] and L2 [f=200 mm]) couples the light into an inverted microscope; a spatial filter (SF) is placed after L1 to select the 1 or −1 order diffraction beam, which contains encoded wavefronts for 3D laser focus control. Lastly, the laser foci perform the designed tasks under the objective lens.

The particle tracking is realized by scanning the target fluorescent particle with a 3×3×3 focus array as shown in FIG. 11b and renewing the scan trajectory with the closed-loop 102 setup in FIG. 11a. For instance, in GPU-only mode, the parallel computing module 702 and task planning module 704 generate fixed trajectory of 2D scanning hologram series. Then, DMD 502 projects corresponding holograms and induces a 2D laser scan within the sample. Once the PMT 706 and FPGA 708 receive feedback intensities that are higher than a preset or calculated threshold, the calculated particle location is sent to the closed-loop 102 control algorithm as an initial parameter. After that, parallel computing module 702, and task planning module 704 generate new holograms to update the particle location. Once the new holograms are loaded to the DMD 502, the FPGA 708 starts to generate triggering signals via a data acquisition card (DAQ) and collect the intensity signals for the next control loop. The LUT-only and GPU-LUT mode also work in the same way as mentioned above.

In an experiment, this closed-loop 102 tracking system can operate at a frame rate of over 12,000 fps, resulting in high-speed particle tracking at a maximum speed of around 200 m/s for a single target. Additionally, the ultrahigh tracking speed enables multi-target tracking capability by sequentially scanning the 3×3×3 foci array around different targets.

Therefore, the ultrafast computing system and method in the present invention are realized via either the GPU, CPU, distributed computing systems, FGPA 708, etc., which can be implemented on hologram displaying devices such as a DMD 502, SLM, DM, etc., to automatically generate digital holograms and control an incoming laser beam for open-loop or closed-loop 102 high-speed wavefront shaping applications. The said parallel computing module 702 in the present invention could reduce the computation time by 10 to 100 times. This enables high-speed closed-loop 102 beam shaping with improved temporal resolution for a wide range of applications. The system and method of the present invention could also accelerate the computation of holograms by arranging multiple frames into a single computing task. The preload of hotspot holograms into the DMD 502 memory and their cooperation with the parallelized CGH algorithm could effectively reduce the time delay induced by hologram generation and data transfer while maintaining the largest wavefront shaping capability. Accordingly, the closed-loop 102 system that is integrated with the ultrafast wavefront shaping system with additional actuators, sensors 106, and control strategies improves the system's stability, precision or accuracy and accomplishes complex tasks at high speeds.

The present invention explained above is not limited to the aforementioned embodiment and drawings, and it will be obvious to those having an ordinary skill in the art of the prevent invention that various replacements, deformations, and changes may be made without departing from the scope of the invention.

We claim:

1. A closed-loop wavefront shaping system, comprising:
a parallel computing module;
a task planning module;
wherein the system is implemented on:
at least one computing device for generating digital holograms;
at least one sensor for detecting feedback signals; and
at least one displaying device for displaying the digital holograms to control an incoming coherent light beam.

2. The closed-loop wavefront shaping system, according to claim 1, wherein the parallel computing module comprises Lee holography.

3. The closed-loop wavefront shaping system, according to claim 2, wherein the displaying device comprises digital micromirror device (DMD).

4. The closed-loop wavefront shaping system, according to claim 3, wherein the Lee holography is solved parallelly based on an equation:
$$h ( i , j ) = \{ \begin{matrix} & & i = tid \% m + 1 \\ 1 , & - q \leq φ ( x , y ) \leq q , & j = tid // n + 1 \\ & & x = {p}_{x} \cdot ( i - m / 2 ) \\ 0 , & otherwise , & y = {p}_{y} \cdot ( j - n / 2 )\end{matrix}$$
wherein h(i,j) is the digital hologram; φ(x,y) is the target wavefront on DMD (502) chip; q is the digitalization constant; and % and // are modulus and floor division, respectively; m, n are the maximum pixel counts in each row and column of a DMD (502); i,j are the pixel indices (coordinates) of a 2D hologram with a range of i1≤i≤i2, j1≤j≤j2 and 1≤i1≤i2≤m, 1≤j1≤j2≤n; tid is the integer index (serialized by rows) of 1D calculating threads with a range of 0≤tid≤m·n−1; x,y are the physical position (coordinates) on a DMD chip; and pₓ and p_{y} are the pixel sizes in the x and y directions.

5. The closed-loop wavefront shaping system, according to claim 3, wherein the Lee holography is solved parallelly based on an equation:
$$h ( i , j ) = \{ \begin{matrix} & & i = tid // m + 1 \\ 1 , & - q \leq φ ( x , y ) \leq q , & j = tid \% n + 1 \\ & & x = {p}_{x} \cdot ( i - m / 2 ) \\ 0 , & otherwise , & y = {p}_{y} \cdot ( j - n / 2 )\end{matrix}$$
wherein h(i,j) is the digital hologram; φ(x,y) is the target wavefront on DMD (502) chip; q is the digitalization constant; and % and // are modulus and floor division, respectively; m, n are the maximum pixel counts in each row and column of a DMD; i,j are the pixel indices (coordinates) of a 2D hologram with a range of i1≤i≤i2, j1≤j≤j2 and 1≤i1≤i2≤m, 1≤j1≤j2≤n; tid is the integer index (serialized by rows) of 1D calculating threads with a range of 0≤tid≤m·n−1; x,y are the physical position (coordinates) on a DMD (502) chip; and pₓ and p_{y} are the pixel sizes in the x and y directions.

6. The closed-loop wavefront shaping system, according to claim 4, wherein the computation of holograms is accelerated by arranging multiple frames into a single computing task.

7. The closed-loop wavefront shaping system, according to claim 1, wherein the task planning module is configured to control, organize, and optimize the performance of the system.

8. The closed-loop wavefront shaping system, according to claim 7, wherein the holograms are determined to be computed individually or in batch.

9. The closed-loop wavefront shaping system, according to claim 1, wherein the computing device comprises at least one or combinations of graphics processing unit (GPU), central processing unit (CPU), distributed computing system, field programmable gate array (FPGA), and the sensor comprises at least one or combinations of camera, photomultiplier tube (PMT), photodiode (PD), avalanche photodiode (APD), single-photon detector (SPD), laser power meter, beam profiler, Shack-Hartmann sensor and spectrometer.

10. The closed-loop wavefront shaping system, according to claim 2, wherein the system further comprises a memory management module configured to reuse holograms that have been preloaded to the on-board memory of displaying devices and coordinate the memory usage between the computing devices and displaying devices.

11. The closed-loop wavefront shaping system, according to claim 1, wherein the system further comprises at least one control module to improve the stability, precision and accuracy of the system and accomplish tasks at high speeds in complex environments.

12. The closed-loop wavefront shaping system, according to claim 1, wherein the displaying device comprises at least one or combinations of spatial light modulator (SLM), deformable mirror (DM), grating light valve (GLV), and planar light valve (PLV).

13. A closed-loop wavefront shaping system, comprising:
a computing module for generating holograms using a computer-generated hologram (CGH) algorithm;
a memory management module, such memory management module is configured to reuse holograms that have been preloaded to the on-board memory of displaying devices and coordinate the memory usage between computing devices and displaying devices;
wherein the system is implemented on:
at least one computing device for generating digital holograms; at least one sensor for detecting feedback signals;
at least one displaying device for displaying the digital holograms to control an incoming coherent light beam.

14. The closed-loop wavefront shaping system, according to claim 13, wherein the system further comprises at least one control module to improve the stability, precision and accuracy of the system and accomplish tasks at high speeds in complex environments.

15. The closed-loop wavefront shaping system, according to claim 13, wherein the displaying device comprises at least one or combinations of digital micromirror device (DMD), spatial light modulator (SLM), deformable mirror (DM), grating light valve (GLV), and planar light valve (PLV).

16. A method of closed-loop wavefront shaping for particle tracking, comprising the steps of:
scanning in a fixed trajectory, such trajectory consists of one or multiple points in 3D space;
acquiring and analyzing fluorescent intensity signals;
repeating the scanning of the fixed trajectory until at least one intensity peak higher than a set threshold is detected;
initializing the location of the particle using the location of the detected intensity peak;
scanning the particle with a 3D foci array;
estimating and renewing the particle location with the detected intensity signals and the foci locations of the 3D foci array;
repeating the scanning of the 3D foci array to form a closed-loop tracking; and
checking the exit criteria during each tracking iteration to decide when to stop the tracking.

17. The method of closed-loop wavefront shaping for particle tracking, according to claim 16, wherein the scanning of the fixed trajectory comprises the steps of:
generating and loading holograms of the fixed trajectory using a parallel computing module and a task planning module;
transferring all holograms to a digital micromirror device (DMD);
sending start commands to the DMD to initiate the fixed trajectory scanning sequence; and
sending trigger signals to the DMD to display holograms one-by-one and simultaneously detecting the corresponding fluorescent intensity signals.

18. The method of closed-loop wavefront shaping for particle tracking, according to claim 16, wherein the repeating of the scanning of the fixed trajectory comprises the steps of:
sending start commands to a digital micromirror device (DMD) to restart the fixed trajectory scanning hologram sequence; and
sending trigger signals to the DMD to display holograms one-by-one and simultaneously detecting the corresponding fluorescent intensity signals.

19. The method of closed-loop wavefront shaping for particle tracking, according to claim 16, wherein the scanning of particle with a 3D foci array comprises the steps of:
transferring the particle location to the parallel computing module and task planning module for generating a 3D foci array around the detected location;
transferring all holograms to a digital micromirror device (DMD) for 3D foci array scanning;
sending start commands to the DMD to initiate the 3D foci array scanning sequence;
sending trigger signals to the DMD to display holograms one-by-one and simultaneously detecting the corresponding fluorescent intensity signals; and
calculating new current location of the particle after getting all the intensity signals.

20. The method of closed-loop wavefront shaping for particle tracking, according to claim 16, wherein the repeating of the scanning of 3D foci array comprises the step of:
sending the new particle location to the parallel computing module and task planning module for generating a 3D foci array around the new particle location;
transferring all holograms to a digital micromirror device (DMD) for 3D foci array scanning;
sending start commands to the DMD to initiate the 3D foci array scanning sequence;
sending trigger signals to the DMD to display holograms one-by-one and simultaneously beginning the corresponding data collection;
detecting fluorescent intensity signals; and
calculating new current location of the particle after getting all the intensity signals.

21. The method of closed-loop wavefront shaping for particle tracking, according to claim 16, wherein the method further comprises the steps of:
generating the holograms that can cover a relatively large 3D space using a parallel computing module and a task planning module;
transferring all holograms to a digital micromirror device (DMD);
generating hologram indices that forms a fixed trajectory using a memory management module, such hologram indices correspond to specific holograms loaded in the DMD;
transferring all hologram indices for fixed trajectory to the DMD;
sending start commands to the DMD to initiate the fixed trajectory sequence; and
sending trigger signals to the DMD to display holograms one-by-one and simultaneously detecting the corresponding fluorescent intensity signals.

22. The method of closed-loop wavefront shaping for particle tracking, according to claim 21, wherein the method further comprises the steps of:
transferring the particle location to the memory management module for generating 3D foci array indices from the loaded holograms around the detected location, such hologram indices correspond to specific holograms loaded in DMD;
transferring all hologram indices for 3D foci array to the DMD;
sending start commands to the DMD to initiate the 3D foci array sequence;
sending trigger signals to the DMD to display holograms one-by-one and simultaneously detecting the corresponding fluorescent intensity signals; and
calculating new current location of the particle after getting all the intensity signals.

23. The method of closed-loop wavefront shaping for particle tracking, according to claim 22, wherein the method further comprises the steps of:
generating new series of holograms to cover a new area if a particle moves near the border of the frame using the parallel computing module and task planning module;
loading the new series of holograms to the DMD;
wherein the old series of holograms in DMD memory is freed to provide enough space for the new series of holograms.

24. A method of closed-loop wavefront shaping for particle tracking, comprising the steps of:
generating and loading 3D scan holograms that can cover a relatively large 3D space using at least one computer-generated hologram (CGH) algorithm;
generating and loading hologram indices for a fixed trajectory using a memory management module, such trajectory comprises one or multiple points in 3D space;
displaying holograms in the fixed trajectory sequence and controlling the laser foci to scan over sample;
acquiring and analyzing fluorescent intensity signals to determine appearance of any intensity peak higher than a set threshold;
repeating the scanning of the fixed trajectory until at least one intensity peak is detected;
initializing the location of the particle using the location of the detected intensity peak;
scanning the particle with hologram indices that forms a 3D foci array, such indices are generated by the memory management module;
estimating and renewing the particle location with the detected intensity signals and the foci locations of the 3D foci array;
repeating the scanning of the 3D foci array to form a closed-loop tracking; and
checking the exit criteria during each tracking iteration to decide when to stop the tracking.

25. The method of closed-loop wavefront shaping for particle tracking, according to claim 24, wherein the generating and loading of hologram indices for the fixed trajectory comprises the steps of:
calculating the hologram indices for the fixed trajectory using memory management module; and
transferring all hologram indices to a digital micromirror device (DMD) for fixed trajectory scanning.

26. The method of closed-loop wavefront shaping for particle tracking, according to claim 24, wherein the repeating of the scanning of fixed trajectory comprises the steps of:
sending start commands to a digital micromirror device (DMD) to restart the fixed trajectory scanning hologram sequence; and
sending trigger signals to the DMD to display holograms one-by-one and simultaneously detecting the corresponding fluorescent intensity signals.

27. The method of closed-loop wavefront shaping for particle tracking, according to claim 24, wherein the scanning of the particle with hologram indices that forms a 3D foci array comprises the steps of:
transferring the particle location to the memory management module for generating hologram indices for 3D foci array around the detected location;
sending start commands to the digital micromirror device (DMD) to initiate the 3D foci array sequence;
sending trigger signals to the DMD to display holograms one-by-one and simultaneously detecting the corresponding fluorescent intensity signals; and
calculating new current location of the particle after getting all the intensity signals.

28. The method of closed-loop wavefront shaping, according to claim 24, wherein the memory management module is configured to coordinate the high- and low-speed memory usage between computing devices and displaying devices and to reuse holograms that have been pre-loaded into the high-speed on-board memory of the displaying device.

29. The method of closed-loop wavefront shaping, according to claim 24, wherein the CGH algorithm includes but not limited to a hologram generating method of a commercial product.
